(19) United States
(12) Patent Application Publication
(10) Pub. No.: US 2020/0374735 A1
(43) Pub. Date: Nov. 26, 2020

(54) SIGNALING ENHANCEMENTS OF SMTC CONFIGURATION FOR AN IAB MT

(71) Applicant: Intel Corporation, Santa Clara, CA (US)

(72) Inventors: Lili Wei, Portland, OR (US); Qian Li, Beaverton, OR (US); Geng Wu, Portland, OR (US)

(21) Appl. No.: 16/991,839

(22) Filed: Aug. 12, 2020

Related U.S. Application Data
(60) Provisional application No. 62/885,995, filed on Aug. 13, 2019.

(51) Int. Cl. H04W 24/10; H04L 5/00; H04W 56/00; H04W 72/00; H04W 24/02; H04W 76/27

(52) U.S. Cl. CPC H04W 24/10; H04L 5/0048; H04W 76/27; H04W 72/005; H04W 24/02; H04W 56/001

(57) ABSTRACT

Embodiments herein provide mechanisms for configuring an integrated access and backhaul (IAB) mobile termination (MT) with one or more SMTCs. In embodiments the IAB MT may receive a radio resource control (RRC) information element (IE) with configuration information for one or more synchronization signal/physical broadcast channel (PBCH) block (SSB) measurement time configurations (SMTCs). For example, in some embodiments, the RRC IE may include configuration information for multiple SMTCs (e.g., 4 SMTCs). The IAB MT may perform one or more measurements on the multiple SMTCs and/or a selected one of the SMTCs. Other embodiments may be described and claimed.

### CROSS REFERENCE TO RELATED APPLICATION

The present application claims priority to U.S. Provisional Patent Application No. 62/885,995, titled “RRC SIGNALING ENHANCEMENTS OF SMTC CONFIGURATION FOR AN IAB MT,” which was filed Aug. 13, 2020, the disclosure of which is hereby incorporated by reference.

### FIELD

Various embodiments generally related to the field of wireless communications.

### BACKGROUND

In New Radio (NR) networks, a user equipment may perform measurements on a synchronization signal (SS)/physical broadcast channel (PBCH) block (SSB). The measurements may be used for cell selection, handover determination, and/or other purposes. The UE receives the SSB within a SSB measurement timing configuration (SMTC) window.

Some networks may include integrated access and backhaul (IAB) nodes that include a IAB mobile termination (MT) to connect with a parent IAB node, and a IAB distributed unit to connect with a child IAB node and/or child UE. The IAB MT may communicate with the parent IAB node similar to a UE. However, SMTC configurations used for a UE may not be suitable for an IAB MT.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an integrated access and backhaul (IAB) network that includes an IAB node, in accordance with various embodiments.

FIG. 2 schematically illustrates a muting pattern group (MPG) in accordance with various embodiments.

FIG. 3 illustrates an operation flow/algorithmic structure in accordance with some embodiments.

FIG. 4 illustrates another operation flow/algorithmic structure in accordance with some embodiments.

FIG. 5 illustrates an example architecture of a system of a network, in accordance with various embodiments.

FIG. 6 illustrates an example of infrastructure equipment in accordance with various embodiments.

FIG. 7 depicts example components of a computer platform or device in accordance with various embodiments.

FIG. 8 depicts example components of baseband circuitry and radio frequency end modules in accordance with various embodiments.

FIG. 9 is a block diagram illustrating components, according to some example embodiments, able to read instructions from a machine-readable or computer-readable medium (for example, a non-transitory machine-readable storage medium) and perform any one or more of the methodologies discussed herein.

### DETAILED DESCRIPTION

In the following detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A or B” and “A and/or B” mean (A), (B), or (A and B). For the purposes of the present disclosure, the phrases “A, B, or C” and “A, B, and/or C” mean (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include any combination of integrated circuits (for example, a field-programmable gate array (FPGA), an application specific integrated circuit (ASIC), etc.), discrete circuits, combinational logic circuits, system on a chip (SOC), system in a package (SiP), that provides the described functionality. In some embodiments, the circuitry may execute one or more software or firmware modules to provide the described functions. In some embodiments, circuitry may include logic, at least partially operable in hardware.

Embodiments herein provide mechanisms for configuring an IAB MT with one or more SMTCs. In embodiments the IAB MT may receive a radio resource control (RRC) information element (IE) with configuration information for one or more SMTCs. For example, in some embodiments, the RRC IE may include configuration information for multiple SMTCs (e.g., 4 SMTCs). The IAB MT may perform one or more measurements on the multiple SMTCs. The IAB MT (and/or the IAB node that includes the IAB MT) may use the measurements and/or SMTC for IAB and inter-IAB node discovery and/or measurements.

In some embodiments, the IE may be a MeasObjectNR IE. In some embodiments, the configuration information for the respective one or more SMTCs may include: a periodicity and offset of the SMTC window; a duration of the SMTC window; a set of SSBs to be measured within the SMTC window; and/or a list of physical cell IDs to be measured during the SMTC window. Additionally, or alternatively, the configuration information may include a muting pattern to indicate one or more SMTC occasions of the respective SMTC to be muted. For example, the configuration information may include a bitmap to indicate the muting pattern, wherein individual bits of the bitmap indicate whether respective SMTC occasions within a muting pattern group (MPG) of SMTC occasions are to be muted.

Accordingly, embodiments herein provide SSB-based solutions regarding SSB Transmission Configuration (STC) and SMTC for IAB nodes. In addition, the SMTC configuration for an IAB MT may include a measurement muting pattern (e.g., to handle STC/SMTC collision). Accordingly, the SMTC configuration for an IAB MT needs to be modified/enhanced compared to SMTC configuration for UEs.

Various embodiments for RRC signaling of SMTC Configuration for an IAB MT disclosed herein include:
Embodiment 1: Define a new RRC IE on measurement timing configuration (MTC) regarding enhanced SMTC configuration for an IAB MT.
Embodiment 2: Add new fields in RRC IE MeasObjectNR regarding four SMTC windows for an IAB MT.
Embodiment 3: Add new fields in System Information Block 2 (SIB2) regarding intra-frequency SMTC configurations for an IAB MT.
Embodiment 4: Add new fields in RRC IE InterFreqCarrierFreqInfo (transmitted in SIB4) regarding inter-frequency SMTC configurations for an IAB MT.
Embodiment 5: Add new fields in SIB4 regarding maximum number of frequencies per SMTC window for an IAB MT.

The disclosed embodiments may be used individually or jointly.

Information on SSBs for Inter-IAB-Node Discovery and Measurements

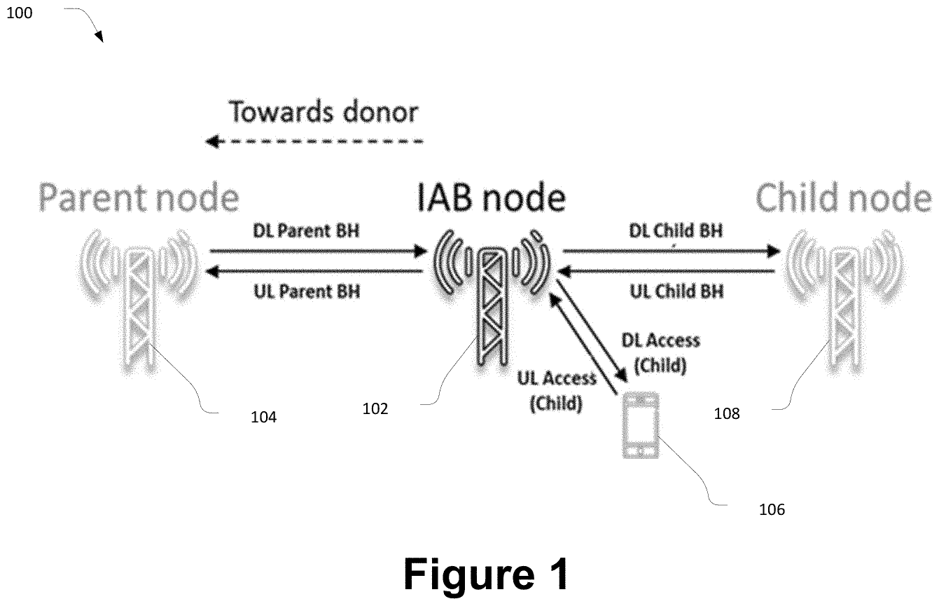

FIG. 1 illustrates an IAB network 100 that includes an IAB node 102, in accordance with various embodiments. The IAB node 102 may connect to a parent IAB node 104 (e.g., an JAB donor or another IAB node) through parent backhaul (BH) link. Additionally, the IAB node 102 may connect to a child UE 106 through a child access (AC) link, and/or connect to a child IAB node 108 through a child BH link. Further aspects of the IAB network 100 may be described in 3GPP Technical Report (TR) 38.874, “NR; Study on integrated access and backhaul.”

In current IAB network architectures, central unit (CU)/distributed unit (DU) split has been leveraged where each IAB node holds a DU and a Mobile-Termination (MT) function: via the MT function, the IAB node connects to its parent IAB node or the IAB-donor like a UE; via the DU function, the IAB node communicates with its child UEs and child MTs like a base station.

An IAB node has different behaviors in Stage 1 and Stage 2, as described further in 3GPP Technical Report (TR) 38.874 v16.0.0, “NR; Study on integrated access and backhaul.” At Stage 1, the IAB MT performs initial access like a UE and set up a connection to a parent IAB-node or an IAB-donor. At Stage 2, the IAB DU becomes active and starts to serve child IAB nodes and/or child UEs. An IAB node connected in the network at Stage 2 needs to transmit synchronization signal blocks (SSBs) for access UEs initial access and SSBs for inter-IAB-node discovery and measurement.

Following acknowledgements have been made on SSB-based solution regarding STC (SSB Transmission Configuration) and SMTC (SSB Measurement Time Configuration) for the purpose of inter-IAB node discovery and measurements:
Introduction of SSB transmission configurations (STC) indicating SSB transmission(s).
   For JAB node discovery and measurement, the maximum number of STCs that can be configured for an JAB node DU per cell at one frequency location is 4.
      Note: this number does not include the cell-defining SSBs for initial access
   All parameters in STC for inter-JAB-node discovery and measurement are provided explicitly, i.e. the default values for the parameters in STC will not be discussed further in RAN1.
   Each STC is independently configured when multiple STCs are configured.
      Up to RAN3 to decide that if SSB index is common across two or more STC configurations, whether additional signaling optimization is necessary or not
   The configurable values of the parameters in STC for JAB node discovery and measurement are provided in the following
      SSB center frequency
         ARFCN-ValueNR
      SSB subcarrier spacing
         FR1: 15 khz, 30 khz
         FR2: 120 khz, 240 khz
      SSB transmission periodicity
         5 ms, 10 ms, 20 ms, 40 ms, 80 ms, 160 ms, 320 ms, 640 ms
      SSB transmission timing offset in half frame(s)
         [0, . . . , (number of half frames within SSB transmission periodicity)−1]
      The index of SSBs to transmit
         Same as Rel-15
      FFS additional parameter(s) other than above
The SSBs for JAB inter-node discovery and measurements are defined with a framework using the characteristics of the Rel-15 SMTC framework with the following enhancements:
   For JAB node discovery and measurement, the maximum number of SMTC windows that can be configured for an JAB node is 4.
   Each SMTC window is provided its own independent configuration (e.g. periodicity, offset, duration).
   The configurable values of the parameters in the SSB reception configurations including SMTC for IAB node discovery and measurement are provided in the following
      SMTC window periodicity:
         5 ms, 10 ms, 20 ms, 40 ms, 80 ms, 160 ms, 320 ms, 640 ms, 1280 ms
      SMTC window timing offset:
         [0, . . . , (number of subframes within SMTC window periodicity)−1]
      SMTC window duration:
         [1, . . . , 5] (subframes)
         FFS larger than 5
      List of physical cell IDs to be measured
         [cell ID 0, . . . , cell IDM-1]
         FFS value ofM
      SSB-ToMeasure
         Same as Rel-15

Based on those acknowledgements, the SMTC configuration for an IAB MT are different from SMTC configuration for a UE in Rel-15 specifications. In addition, the SMTC configuration for an IAB MT may also include measurement muting pattern to handle STC/SMTC collision. SMTC measurement muting can happen either at an IAB MT to allow co-located DU to transmit STC, or at a child MT because of STC muting at an IAB DU. Accordingly, the SMTC configuration for an IAB MT need to be modified/enhanced.

For SMTC configuration in Rel-15 specifications, as described in 3GPP Technical Specification (TS) 38.331 v15.6.0, “NR; RRC protocol specification.”, for intra-frequency CONNECTED mode measurement, up to two measurement window periodicities can be configured, and maximum number of physical cell IDs (PCIS) per SMTC is 64; for inter-frequency measurement, only single SMTC is configured per frequency carrier (up to 8 frequency carriers to be measured) and maximum number of PCIs per SMTC is 16.

Accordingly, there may be several changes on SMTC configuration for an IAB MT.
For IAB node discovery and measurement, the maximum number of SMTC windows that can be configured for an IAB node is 4 at one frequency location.
SMTC window periodicity (1280 ms maximum) and timing offset have been enhanced.
SMTC window duration may be larger than 5 ms.
The maximum number of PCIS to measure per SMTC window is M. (M can be 16 or above).
The maximum number of frequency carriers can be measured is N. (N can be 8 or above).
The SMTC window can be configured to be muted.

With those SMTC updates in IAB network, the SMTC muting pattern design and the RRC signaling enhancements of SMTC configuration for an IAB MT should also be defined accordingly.

SMTC Muting Pattern Configuration Design

In various embodiments, an SMTC muting pattern may be defined for an SMTC configuration, e.g., for an SMTC configuration with an SMTC window periodicity, a timing offset, and/or a window duration. In some embodiments, the SMTC muting pattern may be based on a muting pattern group (MPG) that includes a plurality of SMTC occasions (SOs). One or more of the SOs of the MPG may be muted according to the muting pattern. The muting pattern may repeat across repetitions of the MPG.

The IAB MT may receive an indication of the SMTC muting pattern (e.g., in the configuration information for the SMTC). For example, the indication may include a bitmap, wherein individual bits of the bitmap indicate whether a corresponding SO of the MPG is muted or not.

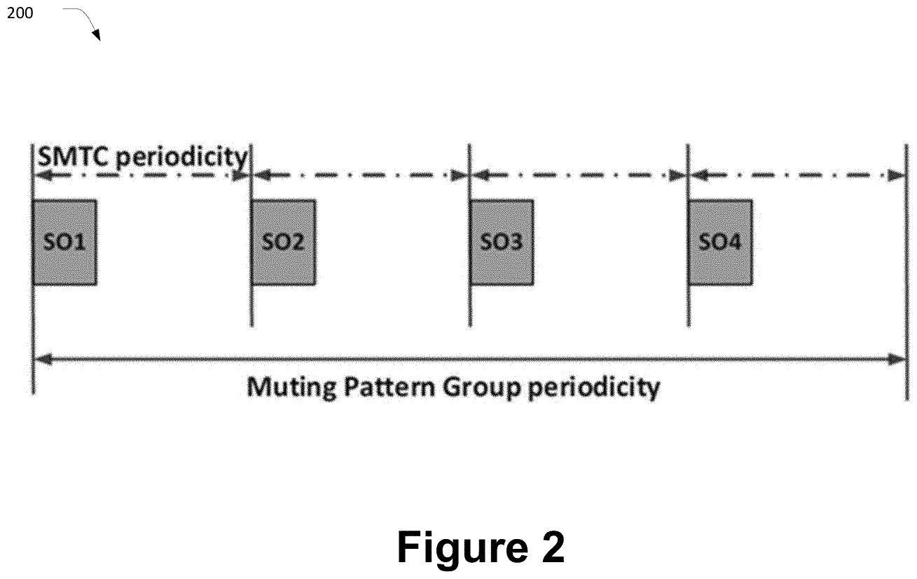

FIG. 2 illustrates a MPG 200 in accordance with various embodiments. The MPG 200 may include a plurality of SOs. For example, the MPG 200 shown in FIG. 2 includes four SOs, SO1, SO2, SO3, and SO4. A bitmap may be used to indicate whether each SO within the MPG 200 is muted or not. For example “0010” for the four SOs in the MPG 200 means the third SO (SO3) is muted for SMTC measurement. This muting pattern group may repeat continuously. If the number of SOs in an MPG is set as Nmpg, the muting pattern group periodicity will be (Nmpg x SMTC periodicity).

Embodiments for RRC Signaling of SMTC Configuration for an IAB MT

Embodiment 1: Define a new RRC IE on measurement timing configuration (MTC) regarding enhanced SMTC configuration for an IAB MT. The RRC IE may be designated for indication of SMTC configuration for IAB nodes (as opposed to UEs).

As the SMTC window configuration for an IAB MT has been enhanced, in some embodiments, an RRC IE (e.g., SSB-MTC-MT) is defined with one or more of the following fields:
periodicityAndOffset: indicates the periodicity and offset of the measurement window for an IAB MT to receive SS/PBCH blocks. It is given in number of subframes.
duration: indicates the duration of the measurement window for an IAB MT to receive SS/PBCH blocks. It is given in number of subframes. Note that the SMTC duration for an IAB MT can be extended from currently defined (1,2,3,4,5 ms) to (1,2,3,4,5, . . . ,x), where x>=5.
ssb-ToMeasure: indicates the set of SS blocks to be measured within the SMTC measurement duration for an IAB MT. When the field is absent, the IAB MT measures on all SS-blocks.
pci-List: indicates physical cell IDs for the SMTC window to measure.
muting-pattern: For a muting pattern group (MPG) of current SMTC occasions, bitmap to indicate which SMTC occasions are muted with that group. The number of SMTC occasions in a MPG can be 2,4,8,16 . . . ,Nmpg.

| SSB-MTC-MT ::= | | SEQUENCE{ |
|---|---|---|
| | periodicityAndOffset | CHOICE { |

| | |
|---|---|
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159), |
| sf320 | INTEGER (0..319), |
| sf640 | INTEGER (0..639), |

| | |
|---|---|
| sf1280 | INTEGER (0..1279), |

},

| duration | ENUMERATED {sf1,sf2,sf3,sf4,sf5,...,sfx}, | | |
|---|---|---|---|
| ssb-ToMeasure | | SSB-ToMeasure , | OPTIONAL |

| | | |
|---|---|---|
| pci-list | SEQUENCE(SIZE(1..maxNrofPCIsPerSMTC-MT))OF PhysCell | OPTIONAL, |

| muting-pattern | CHOICE { |
|---|---|
| gp2 | BIT STRING (SIZE(2)), |
| gp4 | BIT STRING (SIZE(4)), |
| gp8 | BIT STRING (SIZE(8)), |
| gp16 | BIT STRING (SIZE(16)), |
| ... | |
| gpNmpg | BIT STRING (SIZE(Nmpg)), |

| | |
|---|---|
| } | OPTIONAL, |

}

| | |
|---|---|
| maxNrofPCIsPerSMTC-MT | INTEGER ::= M |

The maximum number of physical cell IDs (PCIs) per SMTC window for an IAB MT (maxNrofPCIsPerSMTC-MT) is M (M can be given as greater or equal to 16).

Field Description:

periodicityAndOffset
Periodicity and offset of the measurement window for an IAB MT to receive SS/PBCH blocks. It is
given in number of subframes.
duration
Duration of the measurement window for an IAB MT to receive SS/PBCH blocks. It is given in
number of subframes. (x >= 5)
ssb-ToMeasure-MT
The set of SS blocks to be measured within the SMTC measurement duration for an IAB MT. When
the field is absent, the IAB MT measures on all SS-blocks.
pci-List
Physical cell IDs for the SMTC window to measure.
muting-pattern
For a muting pattern group (MPG) of current SMTC occasions, bitmap to indicate which SMTC
occasions are muted with that group. The number of SMTC occasions in a MPG can be
2, 4, 8, 16 . . . , Nmpg.

Embodiment 2: Add new fields in RRC IE MeasObjectNR regarding four SMTC windows for an IAB MT.

In some embodiments, the following new field are added in RRC IEMeasObjectNR, where RRC IE SSB-MTC-MT is defined in Embodiment 1 of this disclosure.
smtc1-MT: indicates the SMTC window 1 configuration for an IAB MT.
smtc2-MT: indicates the SMTC window 2 configuration for an IAB MT.
smtc3-MT: indicates the SMTC window 3 configuration for an IAB MT.
smtc4-MT: indicates the SMTC window 4 configuration for an IAB MT.

| MeasObjectNR ::= | SEQUENCE { | |
|---|---|---|
| ssbFrequency | ARFCN-ValueNR | OPTIONAL, |

| | | |
|---|---|---|
| ssbSubcarrierSpacing | SubcarrierSpacing | OPTIONAL, |

| | | |
|---|---|---|
| smtc1 | SSB-MTC | OPTIONAL, |

| | | |
|---|---|---|
| smtc2 | SSB-MTC2 | OPTIONAL, |

| | | |
|---|---|---|
| smtc1-MT | SSB-MTC-MT | OPTIONAL, |
| smtc2-MT | SSB-MTC-MT | OPTIONAL, |
| smtc3-MT | SSB-MTC-MT | OPTIONAL, |
| smtc4-MT | SSB-MTC-MT | OPTIONAL, |

| | | |
|---|---|---|
| refFreqCSI-RS | ARFCN-ValueNR | OPTIONAL, |

| | |
|---|---|
| referenceSignalConfig | ReferenceSignalConfig, |

| | | |
|---|---|---|
| absThreshSS-BlocksConsolidation | ThresholdNR | OPTIONAL, |
| absThreshCSI-RS-Consolidation | ThresholdNR | OPTIONAL, |

| | | |
|---|---|---|
| nrofSS-BlocksToAverage | INTEGER (2..maxNrofSS-BlocksToAverage) | OPTIONAL, |

| | | |
|---|---|---|
| nrofCSI-RS-ResourcesToAverage | INTEGER (2..maxNrofCSI-RS-ResourcesToAverage) | OPTIONAL, |

| | |
|---|---|
| quantityConfiglndex | INTEGER (1..maxNrofQuantityConfig), |

| | |
|---|---|
| offsetMO | Q-OffsetRangeList, |

| | | |
|---|---|---|
| cellsToRemoveList | PCI-List | OPTIONAL, |

| | | |
|---|---|---|
| cellsToAddModList | CellsToAddModList | OPTIONAL, |
| blackCellsToRemoveList | PCI-RangelndexList | OPTIONAL, |

blackCellsToAddModList SEQUENCE(SIZE(1..maxNrofPCI-Ranges)) OF PCI-RangeElement OPTIONAL,

| | | |
|---|---|---|
| whiteCellsToRemoveList | PCI-RangelndexList | OPTIONAL, |

```
  whiteCellsToAddModList SEQUENCE(SIZE(1..maxNrofPCI-Ranges)) OF PCI-RangeElement OPTIONAL,
  ...,
  [[
```

| | | |
|---|---|---|
| freqBandIndicatorNR-v1530 | FreqBandIndicatorNR | OPTIONAL, |

| | |
|---|---|
| measCycleSCell-v1530 | ENUMERATED {sf160,sf256,sf320,sf512,sf640,sf1024,sf1280} OPTIONAL |

]]
}

### Field Description:

smtc1-MT
The SMTC window 1 configuration for an IAB MT.
smtc2-MT
The SMTC window 2 configuration for an IAB MT.
smtc3-MT
The SMTC window 3 configuration for an IAB MT.
smtc4-MT
The SMTC window 4 configuration for an IAB MT.

Embodiment 3: Add new fields in SIB2 regarding intra-frequency SMTC configurations for an IAB MT.

In some embodiments, the following new fields are defined in SIB2, where RRC IE SSB-MTC-MT is defined in Embodiment 1 of this disclosure.
smtc1-MT: indicates the SMTC window 1 configuration for intra-frequency measurement for an IAB MT.
smtc2-MT: indicates the SMTC window 2 configuration for intra-frequency measurement for an IAB MT.
smtc3-MT: indicates the SMTC window 3 configuration for intra-frequency measurement for an IAB MT.
smtc4-MT: indicates the SMTC window 4 configuration for intra-frequency measurement for an IAB MT.

| | |
|---|---|
| SIB2 ::= | SEQUENCE { |

| ... | |
|---|---|
| intraFreqCellReselectionInfo | {SEQUENCE |

| q-RxLevMin | Q-RxLevMin | |
|---|---|---|
| q-RxLevMinSUL | Q-RxLevMin | OPTIONAL |

| | | |
|---|---|---|
| q-QualMin | Q-QualMin | OPTIONAL, |

| s-IntraSearchP | ReselectionThreshold, | |
|---|---|---|
| s-IntraSearchQ | ReselectionThresholdQ | OPTIONAL, |

| t-ReselectionNR | T-Reselection, | | |
|---|---|---|---|
| frequencyBandList | MultiFrequencyBandListNR-SIB OPTIONAL, | | |
| frequencyBandListSUL | | MultiFrequencyBandListNR-SIB OPTIONAL, | |
| p-Max | | P-Max | OPTIONAL, |

| | | |
|---|---|---|
| smtc | SSB-MTC | OPTIONAL, |

| | | |
|---|---|---|
| ss-RSSI-Measurement | SS-RSSI-Measurement | OPTIONAL, |

| | | |
|---|---|---|
| ssb-ToMeasure | SSB-ToMeasure | OPTIONAL, |

| | |
|---|---|
| deriveSSB-IndexFromCell | BOOLEAN, |

| | | |
|---|---|---|
| smtc1-MT | SSB-MTC-MT | OPTIONAL, |
| smtc2-MT | SSB-MTC-MT | OPTIONAL, |
| smtc3-MT | SSB-MTC-MT | OPTIONAL, |
| smtc4-MT | SSB-MTC-MT | OPTIONAL, |

| ..., | | |
|---|---|---|
| [[ | | |
| t-ReselectionNR-SF | SpeedStateScaleFactors | OPTIONAL |

]]

},
...

}

### Field Description:

smtc1-MT
SMTC window 1 configuration for intra-frequency measurement for an IAB MT.
smtc2-MT
SMTC window 2 configuration for intra-frequency measurement for an IAB MT.
smtc3-MT
SMTC window 3 configuration for intra-frequency measurement for an IAB MT.
smtc4-MT
SMTC window 4 configuration for intra-frequency measurement for an IAB MT.

Embodiment 4: Add new fields in RRC IE InterFreqCarrierFreqInfo (transmitted in SIB4) regarding inter-frequency SMTC configurations for an IAB MT.

In some embodiments, the following new fields are added in RRC IE InterFreqCarrierFreqInfo.
smtc1-MT: indicates the measurement timing configuration window 1 for inter-frequency measurement for an IAB MT.
smtc2-MT: indicates the measurement timing configuration window 1 for inter-frequency measurement for an IAB MT.
smtc3-MT: indicates the measurement timing configuration window 1 for inter-frequency measurement for an IAB MT.
smtc4-MT: indicates the measurement timing configuration window 1 for inter-frequency measurement for an IAB MT.
interFreqNeighCellList-MT: indicates the list of inter-frequency neighboring cells with specific cell re-selection parameters for an IAB MT.
interFreqBlackCellList-MT: indicates the list of blacklisted inter-frequency neighboring cells for an IAB MT.

RRC IE SSB-MTC-MT is defined in Embodiment 1 of this disclosure. In addition, the following new RRC IEs are defined accordingly.
InterFreqNeighCellList-MT: RRC IE of the list of inter-frequency neighboring cells with specific cell re-selection parameters for an IAB MT, where the maximum number of inter-frequency cells listed in SIB4 for an IAB MT (maxCellInter-MT) is M (M can be given as greater or equal to 16).
InterFreqBlackCellList-MT: RRC IE of the list of blacklisted inter-frequency neighboring cells for an IAB MT, where the maximum number of NR blacklisted cell ranges for an IAB MT (maxCellBlack-MT) is M-BK (M-BK can be given as greater or equal to 16).

InterFreqCarrierFreqInfo ::= SEQUENCE {

| | |
|---|---|
| dl-CarrierFreq | ARFCN-ValueNR, |

| | | |
|---|---|---|
| frequencyBandList | MultiFrequencyBandListNR-SIB | OPTIONAL, |

| | | |
|---|---|---|
| frequencyBandListSUL | MultiFrequencyBandListNR-SIB | OPTIONAL, |

| | |
|---|---|
| nrofSS-BlocksToAverage | INTEGER (2..maxNrofSS-BlocksToAverage) OPTIONAL, |

| | |
|---|---|
| absThreshSS-BlocksConsolidation ThresholdNR | OPTIONAL, |

| | | |
|---|---|---|
| smtc | SSB-MTC | OPTIONAL, |

| | |
|---|---|
| ssbSubcarrierSpacing | SubcarrierSpacing, |

| | | |
|---|---|---|
| ssb-ToMeasure | SSB-ToMeasure | OPTIONAL, |

| deriveSSB-IndexFromCell | BOOLEAN, | |
|---|---|---|
| ss-RSSI-Measurement | SS-RSSI-Measurement | OPTIONAL, |

| | |
|---|---|
| q-RxLevMin | Q-RxLevMin, |

| | | |
|---|---|---|
| q-RxLevMinSUL | Q-RxLevMin | OPTIONAL, |

| | | |
|---|---|---|
| q-QualMin | Q-QualMin | OPTIONAL, |

| | | |
|---|---|---|
| p-Max | P-Max | OPTIONAL, |

| | |
|---|---|
| t-ReselectionNR | T-Reselection, |

| | | |
|---|---|---|
| t-ReselectionNR-SF | SpeedStateScaleFactors | OPTIONAL, |

| | |
|---|---|
| threshX-HigliP | ReselectionThreshold, |
| threshX-LowP | ReselectionThreshold, |

| | |
|---|---|
| threshX-Q | SEQUENCE { |

| | |
|---|---|
| threshX-HighQ | ReselectionThresholdQ, |
| threshX-LowQ | ReselectionThresholdQ |

| | |
|---|---|
| } | OPTIONAL, |

| | | |
|---|---|---|
| cellReselectionPriority | CellReselectionPriority | OPTIONAL, |

| | | |
|---|---|---|
| cellReselectionSubPriority | CellReselectionSubPriority | OPTIONAL, |

| | | |
|---|---|---|
| q-OffsetFreq | Q-OffsetRange | DEFAULT dB0, |

| | | |
|---|---|---|
| interFreqNeighCellList | InterFreqNeighCellList | OPTIONAL, |

| | | |
|---|---|---|
| interFreqBlackCellList | InterFreqBlackCellList | OPTIONAL, |

| | | |
|---|---|---|
| smtc1-MT | SSB-MTC-MT | OPTIONAL, |
| smtc2-MT | SSB-MTC-MT | OPTIONAL, |
| smtc3-MT | SSB-MTC-MT | OPTIONAL, |
| smtc4-MT | SSB-MTC-MT | OPTIONAL, |

| | | |
|---|---|---|
| interFreqNeighCellList-MT | InterFreqNeighCellList-MT | OPTIONAL, |

| | | |
|---|---|---|
| interFreqBlackCellList-MT | InterFreqBlackCellList-MT | OPTIONAL, |

...

}
InterFreqNeighCellList-MT::= SEQUENCE(SIZE (1..maxCellInter-MT)) OF InterFreqNeighCellInfo

| | |
|---|---|
| maxCellInter-MT | INTEGER ::= M |

InterFreqBlackCellList-MT::= SEQUENCE (SIZE (1..maxCellBlack-MT)) OF PCI-Range

| | |
|---|---|
| maxCellBlack-MT | INTEGER ::= M-BK |

### Field Description:

smtc1-MT
SMTC window 1 configuration for inter-frequency measurement for an IAB MT.
smtc2-MT
SMTC window 2 configuration for inter-frequency measurement for an IAB MT.
smtc3-MT
SMTC window 3 configuration for inter-frequency measurement for an IAB MT.
smtc4-MT
SMTC window 4 configuration for inter-frequency measurement for an IAB MT.
interFreqNeighCellList-MT
List of inter-frequency neighboring cells with specific cell re-selection parameters for an IAB MT,
where the maximum number of inter-frequency cells listed in SIB4 for an IAB MT (maxCellInter-MT)
is M (M can be given as greater or equal to 16).
interFreqBlackCellList-MT
List of blacklisted inter-frequency neighboring cells for an IAB MT, where the maximum number of
NR blacklisted cell ranges for an IAB MT (maxCellBlack-MT) is M-BK (M-BK can be given as
greater or equal to 16).

Embodiment 5: Add new fields in SIB4 regarding maximum number of frequencies per SMTC window for an IAB MT.

In some embodiments, the following new field are added in SIB4.
interFreqCarrierFreqList-MT: indicates the list of neighboring carrier frequencies and frequency specific cell re-selection information for an IAB MT, where the maximum number of frequencies to measure for an IAB MT (maxFreq-MT) is N (N can be given as greater or equal to 8).

SIB4 ::= SEQUENCE {

| | |
|---|---|
| interFreqCarrierFreqList | InterFreqCarrierFreqList, |

| | | |
|---|---|---|
| lateNonCriticalExtension | OCTET STRING | OPTIONAL, |

| | | |
|---|---|---|
| interFreqCarrierFreqList-MT | InterFreqCarrierFreqList-MT | OPTIONAL, |

...

}
InterFreqCarrierFreqList-MT ::= SEQUENCE (SIZE(1..maxFreq-MT)) OF InterFreqCarrierFreqInfo

| | |
|---|---|
| maxFreq-MT | INTEGER ::= N |

### Field Description:

interFreqCarrierFreqList-MT
List of neighboring carrier frequencies and frequency specific cell re-selection information for an IAB
MT, where the maximum number of frequencies to measure for an IAB MT (maxFreq-MT) is N (N can
be given as greater or equal to 8).

Note that the embodiments described in this disclosure can be applied individually or jointly.

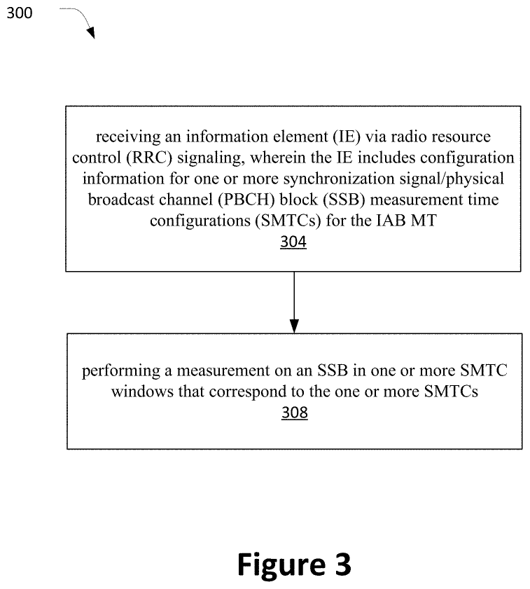

FIG. 3 illustrates an operation flow/algorithmic structure 300 in accordance with various embodiments. The operation flow/algorithmic structure 300 may be performed, in whole or in part, by an IAB MT of an IAB node or components thereof. For example, in some embodiments, the operation flow/algorithmic structure 300 may be performed by baseband circuitry implemented in the IAB MT.

The operation flow/algorithmic structure 300 may include, at 304, receiving an information element (IE) via radio resource control (RRC) signaling, wherein the IE includes configuration information for one or more synchronization signal/physical broadcast channel (PBCH) block (SSB) measurement time configurations (SMTCs) for the IAB MT. For example, the IE may be a MeasObjectNR IE. In some embodiments, the one or more SMTCs may include a plurality of SMTCs, such as 4 SMTCs.

In some embodiments, the configuration information for the respective one or more SMTC includes: a periodicity and offset of the SMTC window; a duration of the SMTC window; a set of SSBs to be measured within the SMTC window; and/or a list of physical cell IDs to be measured during the SMTC window. Additionally, or alternatively, the configuration information may include a muting pattern to indicate one or more SMTC occasions of the respective SMTC to be muted. For example, the configuration information may include a bitmap to indicate the muting pattern, wherein individual bits of the bitmap indicate whether respective SMTC occasions within a muting pattern group (MPG) of SMTC occasions are to be muted.

At 308, the operation flow/algorithmic structure 300 may further include performing a measurement on an SSB in one or more SMTC windows that correspond to the one or more SMTCs. The measurement may be used for any suitable purpose, such as discovery, selection, and/or handover decisions, e.g., related to an IAB parent node.

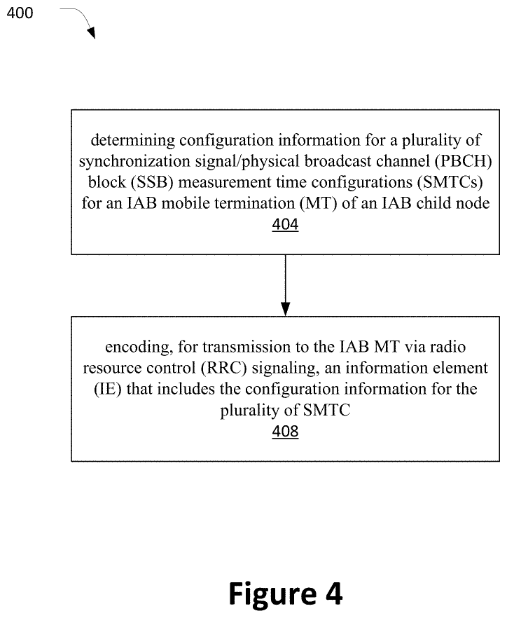

FIG. 4 illustrates another operation flow/algorithmic flow 400 in accordance with various embodiments. The operation flow/algorithmic structure 300 may be performed, in whole or in part, by an IAB node (e.g., an IAB DU of an IAB node), a gNB, or components thereof. For example, in some embodiments, the operation flow/algorithmic structure 300 may be performed by baseband circuitry implemented in an IAB node and/or gNB.

At 404, the operation flow/algorithmic structure 400 may include determining configuration information for a plurality of synchronization signal/physical broadcast channel (PBCH) block (SSB) measurement time configurations (SMTCs) for an IAB mobile termination (MT) of an IAB child node. In some embodiments, the configuration information for the respective one or more SMTC includes: a periodicity and offset of the SMTC window; a duration of the SMTC window; a set of SSBs to be measured within the SMTC window; and/or a list of physical cell IDs to be measured during the SMTC window. Additionally, or alternatively, the configuration information may include a muting pattern to indicate one or more SMTC occasions of the respective SMTC to be muted. For example, the configuration information may include a bitmap to indicate the muting pattern, wherein individual bits of the bitmap indicate whether respective SMTC occasions within a muting pattern group (MPG) of SMTC occasions are to be muted.

At 408, the operation flow/algorithmic structure 400 may further include encoding, for transmission to the IAB MT via radio resource control (RRC) signaling, an information element (IE) that includes the configuration information for the plurality of SMTCs. For example, the IE may be a MeasObjectNR IE. In some embodiments, the one or more SMTCs may include a plurality of SMTCs, such as 4 SMTCs.

### Systems and Implementations

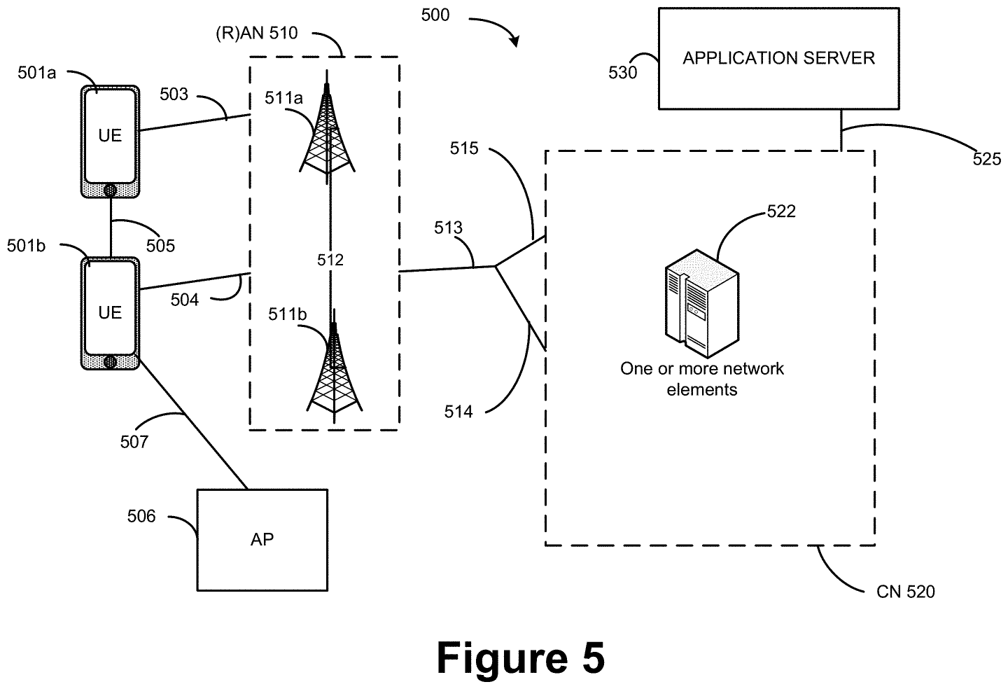

FIG. 5 illustrates an example architecture of a system 500 of a network, in accordance with various embodiments. The following description is provided for an example system 500 that operates in conjunction with the LTE system standards and 5G or NR system standards as provided by 3GPP technical specifications. However, the example embodiments are not limited in this regard and the described embodiments may apply to other networks that benefit from the principles described herein, such as future 3GPP systems (e.g., Sixth Generation (6G)) systems, IEEE 802.16 protocols (e.g., WMAN, WiMAX, etc.), or the like.

As shown by FIG. 5, the system 500 includes UE 501a and UE 501b (collectively referred to as “UEs 501” or “UE 501”). In this example, UEs 501 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 501 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 501 may be configured to connect, for example, communicatively couple, with an or RAN 510. In embodiments, the RAN 510 may be an NG RAN or a 5G RAN, an E-UTRAN, or a legacy RAN, such as a UTRAN or GERAN. As used herein, the term “NG RAN” or the like may refer to a RAN 510 that operates in an NR or 5G system 500, and the term “E-UTRAN” or the like may refer to a RAN 510 that operates in an LTE or 4G system 500. The UEs 501 utilize connections (or channels) 503 and 504, respectively, each of which comprises a physical communications interface or layer (discussed in further detail below).

In this example, the connections 503 and 504 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein. In embodiments, the UEs 501 may directly exchange communication data via a ProSe interface 505. The ProSe interface 505 may alternatively be referred to as a SL interface 505 and may comprise one or more logical channels, including but not limited to a PSCCH, a PSSCH, a PSDCH, and a PSBCH.

The UE 501b is shown to be configured to access an AP 506 (also referred to as “WLAN node 506,” “MILAN 506,” “MILAN Termination 506,” “WT 506” or the like) via connection 507. The connection 507 can comprise a local wireless connection, such as a connection consistent with any IEEE 802.11 protocol, wherein the AP 506 would comprise a wireless fidelity (Wi-Fi®) router. In this example, the AP 506 is shown to be connected to the Internet without connecting to the core network of the wireless system (described in further detail below). In various embodiments, the UE 501b, RAN 510, and AP 506 may be configured to utilize LWA operation and/or LWIP operation. The LWA operation may involve the UE 501b in RRC_CONNECTED being configured by a RAN node 511a-b to utilize radio resources of LTE and WLAN. LWIP operation may involve the UE 501b using WLAN radio resources (e.g., connection 507) via IPsec protocol tunneling to authenticate and encrypt packets (e.g., IP packets) sent over the connection 507. IPsec tunneling may include encapsulating the entirety of original IP packets and adding a new packet header, thereby protecting the original header of the IP packets.

The RAN 510 can include one or more AN nodes or RAN nodes 511a and 511b (collectively referred to as “RAN nodes 511” or “RAN node 511”) that enable the connections 503 and 504. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 511 that operates in an NR or 5G system 500 (for example, a gNB), and the term “E-UTRAN node” or the like may refer to a RAN node 511 that operates in an LTE or 4G system 500 (e.g., an eNB). According to various embodiments, the RAN nodes 511 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In various embodiments, one or more of RAN nodes 511 may implement an IAB node, such as IAB node 102, 104, and/or 108 of FIG. 1.

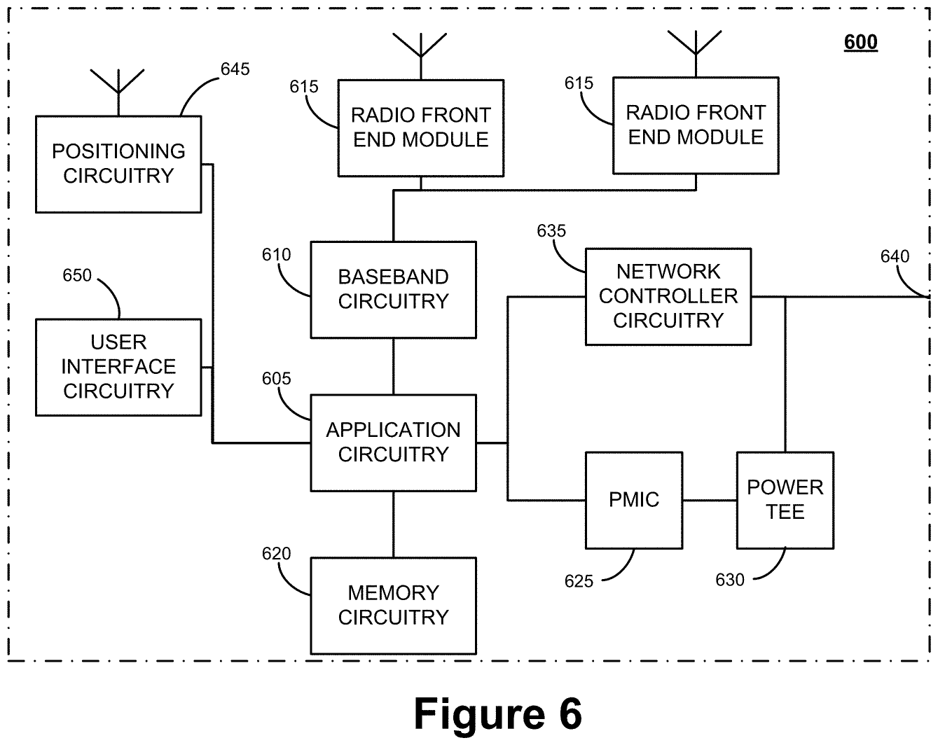

In some embodiments, all or parts of the RAN nodes 511 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 511; a MAC/PHY split wherein RRC, PDCP, RLC, and MAC layers are operated by the CRAN/vBBUP and the PHY layer is operated by individual RAN nodes 511; or a “lower PHY” split wherein RRC, PDCP, RLC, MAC layers and upper portions of the PHY layer are operated by the CRAN/vBBUP and lower portions of the PHY layer are operated by individual RAN nodes 511. This virtualized framework allows the freed-up processor cores of the RAN nodes 511 to perform other virtualized applications. In some implementations, an individual RAN node 511 may represent individual gNB-DUs that are connected to a gNB-CU via individual F1 interfaces (not shown by FIG. 5). In these implementations, the gNB-DUs may include one or more remote radio heads or RFEMs (see, e.g., FIG. 6), and the gNB-CU may be operated by a server that is located in the RAN 510 (not shown) or by a server pool in a similar manner as the CRAN/vBBUP. Additionally or alternatively, one or more of the RAN nodes 511 may be next generation eNBs (ng-eNBs), which are RAN nodes that provide E-UTRA user plane and control plane protocol terminations toward the UEs 501, and are connected to a 5GC (e.g., CN XR220 of Figure XR2) via an NG interface (discussed infra).

In V2X scenarios one or more of the RAN nodes 511 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 501 (vUEs 501). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 511 can terminate the air interface protocol and can be the first point of contact for the UEs 501. In some embodiments, any of the RAN nodes 511 can fulfill various logical functions for the RAN 510 including, but not limited to, radio network controller (RNC) functions such as radio bearer management, uplink and downlink dynamic radio resource management and data packet scheduling, and mobility management.

In embodiments, the UEs 501 can be configured to communicate using OFDM communication signals with each other or with any of the RAN nodes 511 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 511 to the UEs 501, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 501 and the RAN nodes 511 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band.

To operate in the unlicensed spectrum, the UEs 501 and the RAN nodes 511 may operate using LAA, eLAA, and/or feLAA mechanisms. In these implementations, the UEs 501 and the RAN nodes 511 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 501 RAN nodes 511, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 501, AP 506, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds (μs); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 501 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 501. The PDCCH carries information about the transport format and resource allocations related to the PDSCH channel, among other things. It may also inform the UEs 501 about the transport format, resource allocation, and HARQ information related to the uplink shared channel Typically, downlink scheduling (assigning control and shared channel resource blocks to the UE 501b within a cell) may be performed at any of the RAN nodes 511 based on channel quality information fed back from any of the UEs 501. The downlink resource assignment information may be sent on the PDCCH used for (e.g., assigned to) each of the UEs 501.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

The RAN nodes 511 may be configured to communicate with one another via interface 512. In embodiments where the system 500 is an LTE system (e.g., when CN 520 is an EPC XR120 as in Figure XR1), the interface 512 may be an X2 interface 512. The X2 interface may be defined between two or more RAN nodes 511 (e.g., two or more eNBs and the like) that connect to EPC 520, and/or between two eNBs connecting to EPC 520. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 501 from an SeNB for user data; information of PDCP PDUs that were not delivered to a UE 501; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where the system 500 is a 5G or NR system (e.g., when CN 520 is an 5GC XR220 as in Figure XR2), the interface 512 may be an Xn interface 512. The Xn interface is defined between two or more RAN nodes 511 (e.g., two or more gNBs and the like) that connect to 5GC 520, between a RAN node 511 (e.g., a gNB) connecting to 5GC 520 and an eNB, and/or between two eNBs connecting to 5GC 520. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 501 in a connected mode (e.g., CM-CONNECTED) including functionality to manage the UE mobility for connected mode between one or more RAN nodes 511. The mobility support may include context transfer from an old (source) serving RAN node 511 to new (target) serving RAN node 511; and control of user plane tunnels between old (source) serving RAN node 511 to new (target) serving RAN node 511. A protocol stack of the Xn-U may include a transport network layer built on Internet Protocol (IP) transport layer, and a GTP—U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 510 is shown to be communicatively coupled to a core network—in this embodiment, core network (CN) 520. The CN 520 may comprise a plurality of network elements 522, which are configured to offer various data and telecommunications services to customers/subscribers (e.g., users of UEs 501) who are connected to the CN 520 via the RAN 510. The components of the CN 520 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 520 may be referred to as a network slice, and a logical instantiation of a portion of the CN 520 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 530 may be an element offering applications that use IP bearer resources with the core network (e.g., UMTS PS domain, LTE PS data services, etc.). The application server 530 can also be configured to support one or more communication services (e.g., VoIP sessions, PTT sessions, group communication sessions, social networking services, etc.) for the UEs 501 via the EPC 520.

In embodiments, the CN 520 may be a 5GC (referred to as “5GC 520” or the like), and the RAN 510 may be connected with the CN 520 via an NG interface 513. In embodiments, the NG interface 513 may be split into two parts, an NG user plane (NG-U) interface 514, which carries traffic data between the RAN nodes 511 and a UPF, and the S1 control plane (NG-C) interface 515, which is a signaling interface between the RAN nodes 511 and AMFs. Embodiments where the CN 520 is a 5GC 520 are discussed in more detail with regard to Figure XR2.

In embodiments, the CN 520 may be a 5G CN (referred to as “5GC 520” or the like), while in other embodiments, the CN 520 may be an EPC). Where CN 520 is an EPC (referred to as “EPC 520” or the like), the RAN 510 may be connected with the CN 520 via an S1 interface 513. In embodiments, the S1 interface 513 may be split into two parts, an S1 user plane (S1-U) interface 514, which carries traffic data between the RAN nodes 511 and the S-GW, and the S1-MME interface 515, which is a signaling interface between the RAN nodes 511 and MMEs.

FIG. 6 illustrates an example of infrastructure equipment 600 in accordance with various embodiments. The infrastructure equipment 600 (or “system 600”) may be implemented as a base station, radio head, RAN node such as the RAN nodes 511 and/or AP 506 shown and described previously, application server(s) 530, and/or any other element/device discussed herein. In some examples, the system 600 may be implemented in or by an IAB DU of an JAB node, as described herein. In other examples, the system 600 could be implemented in or by a UE.

The system 600 includes application circuitry 605, baseband circuitry 610, one or more radio front end modules (RFEMs) 615, memory circuitry 620, power management integrated circuitry (PMIC) 625, power tee circuitry 630, network controller circuitry 635, network interface connector 640, satellite positioning circuitry 645, and user interface 650. In some embodiments, the device 600 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 605 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or JO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 605 may be coupled with or may include memory/storage elements and may be configured to execute instructions stored in the memory/storage to enable various applications or operating systems to run on the system 600. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 605 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 605 may comprise, or may be, a special-purpose processor/controller to operate according to the various embodiments herein. As examples, the processor(s) of application circuitry 605 may include one or more Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some embodiments, the system 600 may not utilize application circuitry 605, and instead may include a special-purpose processor/controller to process IP data received from an EPC or SGC, for example.

In some implementations, the application circuitry 605 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 605 may comprise logic blocks or logic fabric, and other interconnected resources that may be programmed to perform various functions, such as the procedures, methods, functions, etc. of the various embodiments discussed herein. In such embodiments, the circuitry of application circuitry 605 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up-tables (LUTs) and the like.

The baseband circuitry 610 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 610 are discussed infra with regard to Figure XT.

User interface circuitry 650 may include one or more user interfaces designed to enable user interaction with the system 600 or peripheral component interfaces designed to enable peripheral component interaction with the system 600. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 615 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 811 of Figure XT infra), and the RFEM may be connected to multiple antennas. In alternative implementations, both mmWave and sub-mmWave radio functions may be implemented in the same physical RFEM 615, which incorporates both mmWave antennas and sub-mmWave.

The memory circuitry 620 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 620 may be implemented as one or more of solder down packaged integrated circuits, socketed memory modules and plug-in memory cards.

The PMIC 625 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 630 may provide for electrical power drawn from a network cable to provide both power supply and data connectivity to the infrastructure equipment 600 using a single cable.

The network controller circuitry 635 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 600 via network interface connector 640 using a physical connection, which may be electrical (commonly referred to as a “copper interconnect”), optical, or wireless. The network controller circuitry 635 may include one or more dedicated processors and/or FPGAs to communicate using one or more of the aforementioned protocols. In some implementations, the network controller circuitry 635 may include multiple controllers to provide connectivity to other networks using the same or different protocols.

The positioning circuitry 645 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 645 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 645 may include a Micro-Technology for Positioning, Navigation, and Timing (Micro-PNT) IC that uses a master timing clock to perform position tracking/estimation without GNSS assistance. The positioning circuitry 645 may also be part of, or interact with, the baseband circuitry 610 and/or RFEMs 615 to communicate with the nodes and components of the positioning network. The positioning circuitry 645 may also provide position data and/or time data to the application circuitry 605, which may use the data to synchronize operations with various infrastructure (e.g., RAN nodes 511, etc.), or the like.

The components shown by FIG. 6 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

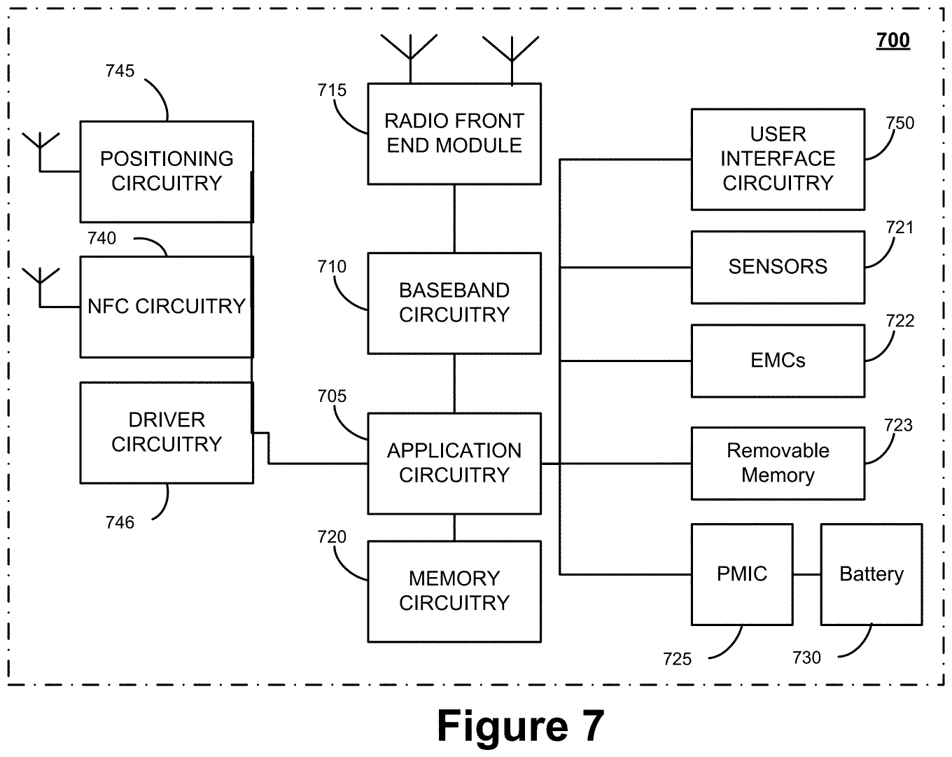

FIG. 7 illustrates an example of a platform 700 (or “device 700”) in accordance with various embodiments. In embodiments, the computer platform 700 may be suitable for use as IAB MTs of an IAB node, UEs 501, application servers 530, and/or any other element/device discussed herein. The platform 700 may include any combinations of the components shown in the example. The components of platform 700 may be implemented as integrated circuits (ICs), portions thereof, discrete electronic devices, or other modules, logic, hardware, software, firmware, or a combination thereof adapted in the computer platform 700, or as components otherwise incorporated within a chassis of a larger system. The block diagram of FIG. 7 is intended to show a high level view of components of the computer platform 700. However, some of the components shown may be omitted, additional components may be present, and different arrangement of the components shown may occur in other implementations.

Application circuitry 705 includes circuitry such as, but not limited to one or more processors (or processor cores), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 705 may be coupled with or may include memory/storage elements and may be configured to execute instructions stored in the memory/storage to enable various applications or operating systems to run on the system 700. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 605 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some embodiments, the application circuitry 605 may comprise, or may be, a special-purpose processor/controller to operate according to the various embodiments herein.

As examples, the processor(s) of application circuitry 705 may include an Intel® Architecture Core™ based processor, such as a Quark™, an Atom™, an i3, an i5, an i7, or an MCU-class processor, or another such processor available from Intel® Corporation, Santa Clara, Calif. The processors of the application circuitry 705 may also be one or more of Advanced Micro Devices (AMD) Ryzen® processor(s) or Accelerated Processing Units (APUs); A5-A9 processor(s) from Apple® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 705 may be a part of a system on a chip (SoC) in which the application circuitry 705 and other components are formed into a single integrated circuit, or a single package, such as the Edison™ or Galileo™ SoC boards from Intel® Corporation.

Additionally or alternatively, application circuitry 705 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such embodiments, the circuitry of application circuitry 705 may comprise logic blocks or logic fabric, and other interconnected resources that may be programmed to perform various functions, such as the procedures, methods, functions, etc. of the various embodiments discussed herein. In such embodiments, the circuitry of application circuitry 705 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. in look-up tables (LUTs) and the like.

The baseband circuitry 710 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 710 are discussed infra with regard to Figure XT.

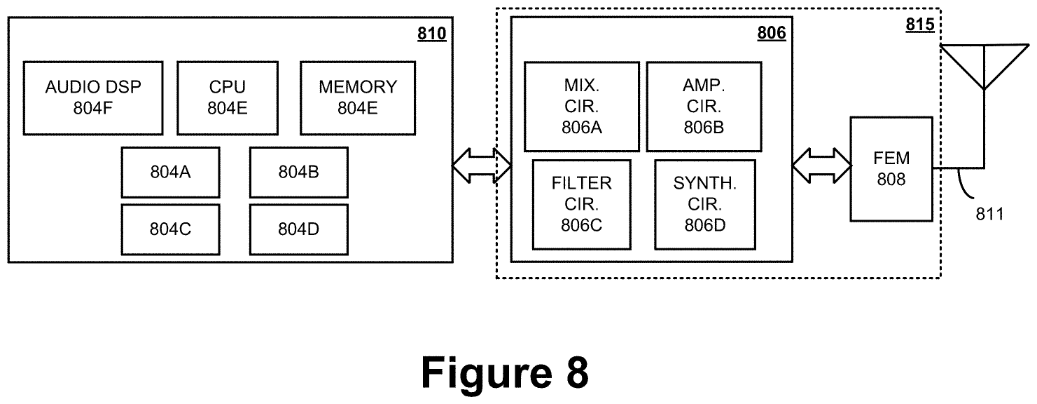

The RFEMs 715 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 811 of FIG. 8 infra), and the RFEM may be connected to multiple antennas. In alternative implementations, both mmWave and sub-mmWave radio functions may be implemented in the same physical RFEM 715, which incorporates both mmWave antennas and sub-mmWave.

The memory circuitry 720 may include any number and type of memory devices used to provide for a given amount of system memory. As examples, the memory circuitry 720 may include one or more of volatile memory including random access memory (RAM), dynamic RAM (DRAM) and/or synchronous dynamic RAM (SDRAM), and nonvolatile memory (NVM) including high-speed electrically erasable memory (commonly referred to as Flash memory), phase change random access memory (PRAM), magnetoresistive random access memory (MRAM), etc. The memory circuitry 720 may be developed in accordance with a Joint Electron Devices Engineering Council (JEDEC) low power double data rate (LPDDR)-based design, such as LPDDR2, LPDDR3, LPDDR4, or the like. Memory circuitry 720 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 720 may be on-die memory or registers associated with the application circuitry 705. To provide for persistent storage of information such as data, applications, operating systems and so forth, memory circuitry 720 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform 700 may incorporate the three-dimensional (3D) cross-point (XPOINT) memories from Intel® and Micron®.

Removable memory circuitry 723 may include devices, circuitry, enclosures/housings, ports or receptacles, etc. used to couple portable data storage devices with the platform 700. These portable data storage devices may be used for mass storage purposes, and may include, for example, flash memory cards (e.g., Secure Digital (SD) cards, microSD cards, xD picture cards, and the like), and USB flash drives, optical discs, external HDDs, and the like.

The platform 700 may also include interface circuitry (not shown) that is used to connect external devices with the platform 700. The external devices connected to the platform 700 via the interface circuitry include sensor circuitry 721 and electro-mechanical components (EMCs) 722, as well as removable memory devices coupled to removable memory circuitry 723.

The sensor circuitry 721 include devices, modules, or subsystems whose purpose is to detect events or changes in its environment and send the information (sensor data) about the detected events to some other a device, module, subsystem, etc. Examples of such sensors include, inter alia, inertia measurement units (IMUs) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

EMCs 722 include devices, modules, or subsystems whose purpose is to enable platform 700 to change its state, position, and/or orientation, or move or control a mechanism or (sub)system. Additionally, EMCs 722 may be configured to generate and send messages/signalling to other components ofthe platform 700 to indicate a current state of the EMCs 722. Examples of the EMCs 722 include one or more power switches, relays including electromechanical relays (EMRs) and/or solid state relays (SSRs), actuators (e.g., valve actuators, etc.), an audible sound generator, a visual warning device, motors (e.g., DC motors, stepper motors, etc.), wheels, thrusters, propellers, claws, clamps, hooks, and/or other like electro-mechanical components. In embodiments, platform 700 is configured to operate one or more EMCs 722 based on one or more captured events and/or instructions or control signals received from a service provider and/or various clients.

In some implementations, the interface circuitry may connect the platform 700 with positioning circuitry 745. The positioning circuitry 745 includes circuitry to receive and decode signals transmitted/broadcasted by a positioning network of a GNSS. Examples of navigation satellite constellations (or GNSS) include United States' GPS, Russia's GLONASS, the European Union's Galileo system, China's BeiDou Navigation Satellite System, a regional navigation system or GNSS augmentation system (e.g., NAVIC), Japan's QZSS, France's DORIS, etc.), or the like. The positioning circuitry 745 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 745 may include a Micro-PNT IC that uses a master timing clock to perform position tracking/estimation without GNSS assistance. The positioning circuitry 745 may also be part of, or interact with, the baseband circuitry 610 and/or RFEMs 715 to communicate with the nodes and components of the positioning network. The positioning circuitry 745 may also provide position data and/or time data to the application circuitry 705, which may use the data to synchronize operations with various infrastructure (e.g., radio base stations), for turn-by-turn navigation applications, or the like

In some implementations, the interface circuitry may connect the platform 700 with Near-Field Communication (NFC) circuitry 740. NFC circuitry 740 is configured to provide contactless, short-range communications based on radio frequency identification (RFID) standards, wherein magnetic field induction is used to enable communication between NFC circuitry 740 and NFC-enabled devices external to the platform 700 (e.g., an “NFC touchpoint”). NFC circuitry 740 comprises an NFC controller coupled with an antenna element and a processor coupled with the NFC controller. The NFC controller may be a chip/IC providing NFC functionalities to the NFC circuitry 740 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 740, or initiate data transfer between the NFC circuitry 740 and another active NFC device (e.g., a smartphone or an NFC-enabled POS terminal) that is proximate to the platform 700.

The driver circuitry 746 may include software and hardware elements that operate to control particular devices that are embedded in the platform 700, attached to the platform 700, or otherwise communicatively coupled with the platform 700. The driver circuitry 746 may include individual drivers allowing other components of the platform 700 to interact with or control various input/output (I/O) devices that may be present within, or connected to, the platform 700. For example, driver circuitry 746 may include a display driver to control and allow access to a display device, a touchscreen driver to control and allow access to a touchscreen interface of the platform 700, sensor drivers to obtain sensor readings of sensor circuitry 721 and control and allow access to sensor circuitry 721, EMC drivers to obtain actuator positions of the EMCs 722 and/or control and allow access to the EMCs 722, a camera driver to control and allow access to an embedded image capture device, audio drivers to control and allow access to one or more audio devices.

The power management integrated circuitry (PMIC) 725 (also referred to as “power management circuitry 725”) may manage power provided to various components of the platform 700. In particular, with respect to the baseband circuitry 710, the PMIC 725 may control power-source selection, voltage scaling, battery charging, or DC-to-DC conversion. The PMIC 725 may often be included when the platform 700 is capable of being powered by a battery 730, for example, when the device is included in a UE 501, XR101, XR201.

In some embodiments, the PMIC 725 may control, or otherwise be part of, various power saving mechanisms of the platform 700. For example, if the platform 700 is in an RRC_Connected state, where it is still connected to the RAN node as it expects to receive traffic shortly, then it may enter a state known as Discontinuous Reception Mode (DRX) after a period of inactivity. During this state, the platform 700 may power down for brief intervals of time and thus save power. If there is no data traffic activity for an extended period of time, then the platform 700 may transition off to an RRC_Idle state, where it disconnects from the network and does not perform operations such as channel quality feedback, handover, etc. The platform 700 goes into a very low power state and it performs paging where again it periodically wakes up to listen to the network and then powers down again. The platform 700 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 730 may power the platform 700, although in some examples the platform 700 may be mounted deployed in a fixed location, and may have a power supply coupled to an electrical grid. The battery 730 may be a lithium ion battery, a metal-air battery, such as a zinc-air battery, an aluminum-air battery, a lithium-air battery, and the like. In some implementations, such as in V2X applications, the battery 730 may be a typical lead-acid automotive battery.

In some implementations, the battery 730 may be a “smart battery,” which includes or is coupled with a Battery Management System (BMS) or battery monitoring integrated circuitry. The BMS may be included in the platform 700 to track the state of charge (SoCh) of the battery 730. The BMS may be used to monitor other parameters of the battery 730 to provide failure predictions, such as the state of health (SoH) and the state of function (SoF) of the battery 730. The BMS may communicate the information of the battery 730 to the application circuitry 705 or other components of the platform 700. The BMS may also include an analog-to-digital (ADC) convertor that allows the application circuitry 705 to directly monitor the voltage of the battery 730 or the current flow from the battery 730. The battery parameters may be used to determine actions that the platform 700 may perform, such as transmission frequency, network operation, sensing frequency, and the like.

A power block, or other power supply coupled to an electrical grid may be coupled with the BMS to charge the battery 730. In some examples, the power block XS30 may be replaced with a wireless power receiver to obtain the power wirelessly, for example, through a loop antenna in the computer platform 700. In these examples, a wireless battery charging circuit may be included in the BMS. The specific charging circuits chosen may depend on the size of the battery 730, and thus, the current required. The charging may be performed using the Airfuel standard promulgated by the Airfuel Alliance, the Qi wireless charging standard promulgated by the Wireless Power Consortium, or the Rezence charging standard promulgated by the Alliance for Wireless Power, among others.

User interface circuitry 750 includes various input/output (I/O) devices present within, or connected to, the platform 700, and includes one or more user interfaces designed to enable user interaction with the platform 700 and/or peripheral component interfaces designed to enable peripheral component interaction with the platform 700. The user interface circuitry 750 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 700. The output device circuitry may also include speakers or other audio emitting devices, printer(s), and/or the like. In some embodiments, the sensor circuitry 721 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

Although not shown, the components of platform 700 may communicate with one another using a suitable bus or interconnect (IX) technology, which may include any number of technologies, including ISA, EISA, PCI, PCIx, PCIe, a Time-Trigger Protocol (TTP) system, a FlexRay system, or any number of other technologies. The bus/IX may be a proprietary bus/IX, for example, used in a SoC based system. Other bus/IX systems may be included, such as an I2C interface, an SPI interface, point-to-point interfaces, and a power bus, among others.

FIG. 8 illustrates example components of baseband circuitry 810 and radio front end modules (RFEM) 815 in accordance with various embodiments. The baseband circuitry 810 corresponds to the baseband circuitry 610 and 710 of FIGS. 6 and 7, respectively. The RFEM 815 corresponds to the RFEM 615 and 715 of FIGS. 6 and 7, respectively. As shown, the RFEMs 815 may include Radio Frequency (RF) circuitry 806, front-end module (FEM) circuitry 808, antenna array 811 coupled together at least as shown.

The baseband circuitry 810 includes circuitry and/or control logic configured to carry out various radio/network protocol and radio control functions that enable communication with one or more radio networks via the RF circuitry 806. The radio control functions may include, but are not limited to, signal modulation/demodulation, encoding/decoding, radio frequency shifting, etc. In some embodiments, modulation/demodulation circuitry of the baseband circuitry 810 may include Fast-Fourier Transform (FFT), precoding, or constellation mapping/demapping functionality. In some embodiments, encoding/decoding circuitry of the baseband circuitry 810 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 810 is configured to process baseband signals received from a receive signal path of the RF circuitry 806 and to generate baseband signals for a transmit signal path of the RF circuitry 806. The baseband circuitry 810 is configured to interface with application circuitry 605/705 (see FIGS. 6 and 7) for generation and processing of the baseband signals and for controlling operations of the RF circuitry 806. The baseband circuitry 810 may handle various radio control functions.

The aforementioned circuitry and/or control logic of the baseband circuitry 810 may include one or more single or multi-core processors. For example, the one or more processors may include a 3G baseband processor 804A, a 4G/LTE baseband processor 804B, a 5G/NR baseband processor 804C, or some other baseband processor(s) 804D for other existing generations, generations in development or to be developed in the future (e.g., sixth generation (6G), etc.). In other embodiments, some or all of the functionality of baseband processors 804A-D may be included in modules stored in the memory 804G and executed via a Central Processing Unit (CPU) 804E. In other embodiments, some or all of the functionality of baseband processors 804A-D may be provided as hardware accelerators (e.g., FPGAs, ASICs, etc.) loaded with the appropriate bit streams or logic blocks stored in respective memory cells. In various embodiments, the memory 804G may store program code of a real-time OS (RTOS), which when executed by the CPU 804E (or other baseband processor), is to cause the CPU 804E (or other baseband processor) to manage resources of the baseband circuitry 810, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein. In addition, the baseband circuitry 810 includes one or more audio digital signal processor(s) (DSP) 804F. The audio DSP(s) 804F include elements for compression/decompression and echo cancellation and may include other suitable processing elements in other embodiments.

In some embodiments, each of the processors 804A-804E include respective memory interfaces to send/receive data to/from the memory 804G. The baseband circuitry 810 may further include one or more interfaces to communicatively couple to other circuitries/devices, such as an interface to send/receive data to/from memory external to the baseband circuitry 810; an application circuitry interface to send/receive data to/from the application circuitry 605/705 of FIG. 6-XT); an RF circuitry interface to send/receive data to/from RF circuitry 806 of Figure XT; a wireless hardware connectivity interface to send/receive data to/from one or more wireless hardware elements (e.g., Near Field Communication (NFC) components, Bluetooth®/Bluetooth® Low Energy components, Wi-Fi® components, and/or the like); and a power management interface to send/receive power or control signals to/from the PMIC 725. [000117]M alternate embodiments (which may be combined with the above described embodiments), baseband circuitry 810 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 810 may include protocol processing circuitry with one or more instances of control circuitry (not shown) to provide control functions for the digital baseband circuitry and/or radio frequency circuitry (e.g., the radio front end modules 815).

Although not shown by Figure XT, in some embodiments, the baseband circuitry 810 includes individual processing device(s) to operate one or more wireless communication protocols (e.g., a “multi-protocol baseband processor” or “protocol processing circuitry”) and individual processing device(s) to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or 5G/NR protocol entities when the baseband circuitry 810 and/or RF circuitry 806 are part of mmWave communication circuitry or some other suitable cellular communication circuitry. In the first example, the protocol processing circuitry would operate MAC, RLC, PDCP, SDAP, RRC, and NAS functions. In a second example, the protocol processing circuitry may operate one or more IEEE-based protocols when the baseband circuitry 810 and/or RF circuitry 806 are part of a Wi-Fi communication system. In the second example, the protocol processing circuitry would operate Wi-Fi MAC and logical link control (LLC) functions. The protocol processing circuitry may include one or more memory structures (e.g., 804G) to store program code and data for operating the protocol functions, as well as one or more processing cores to execute the program code and perform various operations using the data. The baseband circuitry 810 may also support radio communications for more than one wireless protocol.

The various hardware elements of the baseband circuitry 810 discussed herein may be implemented, for example, as a solder-down substrate including one or more integrated circuits (ICs), a single packaged IC soldered to a main circuit board or a multi-chip module containing two or more ICs. In one example, the components of the baseband circuitry 810 may be suitably combined in a single chip or chipset, or disposed on a same circuit board. In another example, some or all of the constituent components of the baseband circuitry 810 and RF circuitry 806 may be implemented together such as, for example, a system on a chip (SoC) or System-in-Package (SiP). In another example, some or all of the constituent components of the baseband circuitry 810 may be implemented as a separate SoC that is communicatively coupled with and RF circuitry 806 (or multiple instances of RF circuitry 806). In yet another example, some or all of the constituent components of the baseband circuitry 810 and the application circuitry 605/705 may be implemented together as individual SoCs mounted to a same circuit board (e.g., a “multi-chip package”).

In some embodiments, the baseband circuitry 810 may provide for communication compatible with one or more radio technologies. For example, in some embodiments, the baseband circuitry 810 may support communication with an E-UTRAN or other WMAN, a WLAN, a WPAN. Embodiments in which the baseband circuitry 810 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path, which may include circuitry to down-convert RF signals received from the FEM circuitry 808 and provide baseband signals to the baseband circuitry 810. RF circuitry 806 may also include a transmit signal path, which may include circuitry to up-convert baseband signals provided by the baseband circuitry 810 and provide RF output signals to the FEM circuitry 808 for transmission.

In some embodiments, the receive signal path of the RF circuitry 806 may include mixer circuitry 806a, amplifier circuitry 806b and filter circuitry 806c. In some embodiments, the transmit signal path of the RF circuitry 806 may include filter circuitry 806c and mixer circuitry 806a. RF circuitry 806 may also include synthesizer circuitry 806d for synthesizing a frequency for use by the mixer circuitry 806a of the receive signal path and the transmit signal path. In some embodiments, the mixer circuitry 806a of the receive signal path may be configured to down-convert RF signals received from the FEM circuitry 808 based on the synthesized frequency provided by synthesizer circuitry 806d. The amplifier circuitry 806b may be configured to amplify the down-converted signals and the filter circuitry 806c may be a low-pass filter (LPF) or band-pass filter (BPF) configured to remove unwanted signals from the down-converted signals to generate output baseband signals. Output baseband signals may be provided to the baseband circuitry 810 for further processing. In some embodiments, the output baseband signals may be zero-frequency baseband signals, although this is not a requirement. In some embodiments, mixer circuitry 806a of the receive signal path may comprise passive mixers, although the scope of the embodiments is not limited in this respect.

In some embodiments, the mixer circuitry 806a of the transmit signal path may be configured to up-convert input baseband signals based on the synthesized frequency provided by the synthesizer circuitry 806d to generate RF output signals for the FEM circuitry 808. The baseband signals may be provided by the baseband circuitry 810 and may be filtered by filter circuitry 806c.

In some embodiments, the mixer circuitry 806a of the receive signal path and the mixer circuitry 806a of the transmit signal path may include two or more mixers and may be arranged for quadrature downconversion and upconversion, respectively. In some embodiments, the mixer circuitry 806a of the receive signal path and the mixer circuitry 806a of the transmit signal path may include two or more mixers and may be arranged for image rejection (e.g., Hartley image rejection). In some embodiments, the mixer circuitry 806a of the receive signal path and the mixer circuitry 806a of the transmit signal path may be arranged for direct downconversion and direct upconversion, respectively. In some embodiments, the mixer circuitry 806a of the receive signal path and the mixer circuitry 806a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 810 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806d may be a fractional-N synthesizer or a fractional N/N+1 synthesizer, although the scope of the embodiments is not limited in this respect as other types of frequency synthesizers may be suitable. For example, synthesizer circuitry 806d may be a delta-sigma synthesizer, a frequency multiplier, or a synthesizer comprising a phase-locked loop with a frequency divider.

The synthesizer circuitry 806d may be configured to synthesize an output frequency for use by the mixer circuitry 806a of the RF circuitry 806 based on a frequency input and a divider control input. In some embodiments, the synthesizer circuitry 806d may be a fractional N/N+1 synthesizer.

In some embodiments, frequency input may be provided by a voltage controlled oscillator (VCO), although that is not a requirement. Divider control input may be provided by either the baseband circuitry 810 or the application circuitry 605/705 depending on the desired output frequency. In some embodiments, a divider control input (e.g., N) may be determined from a look-up table based on a channel indicated by the application circuitry 605/705.

Synthesizer circuitry 806d of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path, which may include circuitry configured to operate on RF signals received from antenna array 811, amplify the received signals and provide the amplified versions of the received signals to the RF circuitry 806 for further processing. FEM circuitry 808 may also include a transmit signal path, which may include circuitry configured to amplify signals for transmission provided by the RF circuitry 806 for transmission by one or more of antenna elements of antenna array 811. In various embodiments, the amplification through the transmit or receive signal paths may be done solely in the RF circuitry 806, solely in the FEM circuitry 808, or in both the RF circuitry 806 and the FEM circuitry 808.

In some embodiments, the FEM circuitry 808 may include a TX/RX switch to switch between transmit mode and receive mode operation. The FEM circuitry 808 may include a receive signal path and a transmit signal path. The receive signal path of the FEM circuitry 808 may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission by one or more antenna elements of the antenna array 811.

The antenna array 811 comprises one or more antenna elements, each of which is configured convert electrical signals into radio waves to travel through the air and to convert received radio waves into electrical signals. For example, digital baseband signals provided by the baseband circuitry 810 is converted into analog RF signals (e.g., modulated waveform) that will be amplified and transmitted via the antenna elements of the antenna array 811 including one or more antenna elements (not shown). The antenna elements may be omnidirectional, direction, or a combination thereof. The antenna elements may be formed in a multitude of arranges as are known and/or discussed herein. The antenna array 811 may comprise microstrip antennas or printed antennas that are fabricated on the surface of one or more printed circuit boards. The antenna array 811 may be formed in as a patch of metal foil (e.g., a patch antenna) in a variety of shapes, and may be coupled with the RF circuitry 806 and/or FEM circuitry 808 using metal transmission lines or the like.

Processors of the application circuitry 605/705 and processors of the baseband circuitry 810 may be used to execute elements of one or more instances of a protocol stack. For example, processors of the baseband circuitry 810, alone or in combination, may be used execute Layer 3, Layer 2, or Layer 1 functionality, while processors of the application circuitry 605/705 may utilize data (e.g., packet data) received from these layers and further execute Layer 4 functionality (e.g., TCP and UDP layers). As referred to herein, Layer 3 may comprise a RRC layer, described in further detail below. As referred to herein, Layer 2 may comprise a MAC layer, an RLC layer, and a PDCP layer, described in further detail below. As referred to herein, Layer 1 may comprise a PHY layer of a UE/RAN node, described in further detail below.

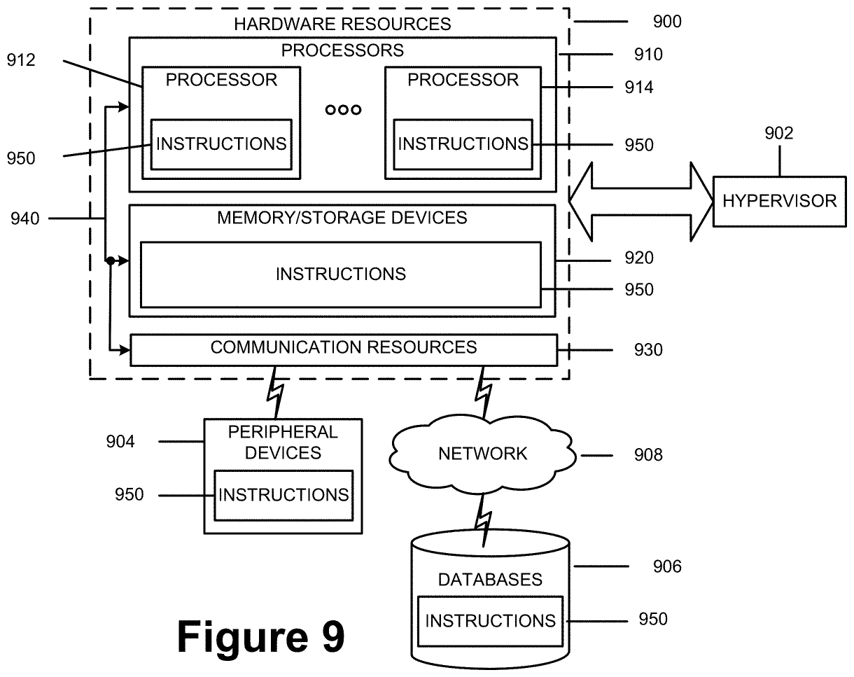

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940. For embodiments where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914. The processor(s) 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface components or other suitable devices to communicate with one or more peripheral devices 904 or one or more databases 906 via a network 908. For example, the communication resources 930 may include wired communication components (e.g., for coupling via USB), cellular communication components, NFC components, Bluetooth® (or Bluetooth® Low Energy) components, Wi-Fi® components, and other communication components..

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 is one or more non-transitory computer-readable media (NTCRM) having instructions, stored thereon, that when executed by one or more processors cause an integrated access and backhaul (IAB) mobile termination (MT) device to: receive an information element (IE) via radio resource control (RRC) signaling, wherein the IE includes configuration information for one or more synchronization signal/physical broadcast channel (PBCH) block (SSB) measurement time configurations (SMTCs) for the IAB MT; and perform a measurement on an SSB in one or more SMTC windows that correspond to the one or more SMTCs.

Example 2 is the one or more NTCRM of Example 1, wherein the configuration information for the respective one or more SMTC includes: a periodicity and offset of the SMTC window; a duration of the SMTC window; a set of SSBs to be measured within the SMTC window; and a list of physical cell IDs to be measured during the SMTC window.

Example 3 is the one or more NTCRM of Example 1, wherein the configuration information includes a muting pattern to indicate one or more SMTC occasions of the respective SMTC to be muted.

Example 4 is the one or more NTCRM of Example 3, wherein the configuration information includes a bitmap to indicate the muting pattern, wherein individual bits of the bitmap indicate whether respective SMTC occasions within a muting pattern group (MPG) of SMTC occasions are to be muted.

Example 5 is the one or more NTCRM of Example 1, wherein the one or more SMTCs is 4 SMTCs.

Example 6 is the one or more NTCRM of Example 5, wherein the IE is a MeasObjectNR IE.

Example 7 is the one or more NTCRM of Example 1, wherein the configuration information further includes an indication of a maximum number of physical cell IDs per SMTC window.

Example 8 is the one or more NTCRM of Example 1, wherein the SMTC windows are for intra-frequency measurements.

Example 9 is the one or more NTCRM of Example 1, wherein the SMTC windows are for inter-frequency measurements.

Example 10 is the one or more NTCRM of Example 9, wherein the IE further includes: a list of inter-frequency cells with specific cell re-selection parameters; and a list of blacklisted inter-frequency cells.

Example 11 is one or more non-transitory computer-readable media (NTCRM) having instructions, stored thereon, that when executed by one or more processors cause an integrated access and backhaul (IAB) parent node to: determine configuration information for a plurality of synchronization signal/physical broadcast channel (PBCH) block (SSB) measurement time configurations (SMTCs) for an IAB mobile termination (MT) of an IAB child node; and encode, for transmission to the IAB MT via radio resource control (RRC) signaling, an information element (IE) that includes the configuration information for the plurality of SMTCs.

Example 12 is the one or more NTCRM of Example 11, further comprising encoding an SSB for transmission in one or more or a plurality of SMTC windows that correspond to the respective SMTCs.

Example 13 is the one or more NTCRM of Example 11, wherein the configuration information for the plurality of SMTCs includes: a periodicity and offset of an SMTC window that corresponds to the respective SMTC; a duration of the SMTC window; a set of SSBs to be measured within the SMTC window; and a list of physical cell IDs to be measured during the SMTC window.

Example 14 is the one or more NTCRM of Example 11, wherein the configuration information includes a muting pattern to indicate one or more SMTC occasions of the respective SMTC to be muted.

Example 15 is the one or more NTCRM of Example 14, wherein the configuration information includes a bitmap to indicate the muting pattern, wherein individual bits of the bitmap indicate whether respective SMTC occasions within a muting pattern group (MPG) of SMTC occasions are to be muted.

Example 16 is the one or more NTCRM of Example 1, wherein the plurality of SMTCs is 4 SMTCs.

Example 17 is an apparatus to be implemented in an integrated access and backhaul (IAB) mobile termination (MT), the apparatus comprising processor circuitry to receive an MeasObjectNR information element (IE) via radio resource control (RRC) signaling, wherein the MeasObjectNR IE includes configuration information for a plurality of synchronization signal/physical broadcast channel (PBCH) block (SSB) measurement time configurations (SMTCs) for the IAB MT. The apparatus further comprises a memory to store the configuration information.

Example 18 is the apparatus of Example 17, wherein the configuration information for the respective one or more SMTC includes: a periodicity and offset of the SMTC window; a duration of the SMTC window; a set of SSBs to be measured within the SMTC window; and a list of physical cell IDs to be measured during the SMTC window.

Example 19 is the apparatus of Example 17, wherein the configuration information includes a muting pattern to indicate one or more SMTC occasions of the respective SMTC to be muted.

Example 20 is the apparatus of Example 19, wherein the configuration information includes a bitmap to indicate the muting pattern, wherein individual bits of the bitmap indicate whether respective SMTC occasions within a muting pattern group (MPG) of SMTC occasions are to be muted.

Example 21 is the apparatus of Example 17, wherein the plurality of SMTCs is 4 SMTCs.

Example 22 is the apparatus of Example 17, wherein the processor circuitry is further to perform measurements on an SSB in one or more SMTC windows that correspond to the respective SMTCs.

Example 23 may include an apparatus comprising means to perform one or more elements of a method described in or related to any of examples 1-22, or any other method or process described herein.

Example 24 may include one or more non-transitory computer-readable media comprising instructions to cause an electronic device, upon execution of the instructions by one or more processors of the electronic device, to perform one or more elements of a method described in or related to any of examples 1-22, or any other method or process described herein.

Example 25 may include an apparatus comprising logic, modules, or circuitry to perform one or more elements of a method described in or related to any of examples 1-22, or any other method or process described herein.

Example 26 may include a method, technique, or process as described in or related to any of examples 1-22, or portions or parts thereof.

Example 27 may include an apparatus comprising: one or more processors and one or more computer-readable media comprising instructions that, when executed by the one or more processors, cause the one or more processors to perform the method, techniques, or process as described in or related to any of examples 1-22, or portions thereof.

Example 28 may include a signal as described in or related to any of examples 1-22, or portions or parts thereof.

Example 29 may include a datagram, packet, frame, segment, protocol data unit (PDU), or message as described in or related to any of examples 1-22, or portions or parts thereof, or otherwise described in the present disclosure.

Example 30 may include a signal encoded with data as described in or related to any of examples 1-22, or portions or parts thereof, or otherwise described in the present disclosure.

Example 31 may include a signal encoded with a datagram, packet, frame, segment, protocol data unit (PDU), or message as described in or related to any of examples 1-22, or portions or parts thereof, or otherwise described in the present disclosure.

Example 32 may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Example 33 may include a computer program comprising instructions, wherein execution of the program by a processing element is to cause the processing element to carry out the method, techniques, or process as described in or related to any of examples 1-22, or portions thereof.

Example 34 may include a signal in a wireless network as shown and described herein.

Example 35 may include a method of communicating in a wireless network as shown and described herein.

Example 36 may include a system for providing wireless communication as shown and described herein.

Example 37 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

1. One or more non-transitory computer-readable media (NTCRM) having instructions, stored thereon, that when executed by one or more processors cause an integrated access and backhaul (IAB) mobile termination (MT) device to:
receive an information element (IE) via radio resource control (RRC) signaling, wherein the IE includes configuration information for one or more synchronization signal/physical broadcast channel (PBCH) block (SSB) measurement time configurations (SMTCs) for the IAB MT; and
perform a measurement on an SSB in one or more SMTC windows that correspond to the one or more SMTCs.

2. The one or more NTCRM of claim 1, wherein the configuration information for the respective one or more SMTC includes:
a periodicity and offset of the SMTC window;
a duration of the SMTC window;
a set of SSBs to be measured within the SMTC window; and
a list of physical cell IDs to be measured during the SMTC window.

3. The one or more NTCRM of claim 1, wherein the configuration information includes a muting pattern to indicate one or more SMTC occasions of the respective SMTC to be muted.

4. The one or more NTCRM of claim 3, wherein the configuration information includes a bitmap to indicate the muting pattern, wherein individual bits of the bitmap indicate whether respective SMTC occasions within a muting pattern group (MPG) of SMTC occasions are to be muted.

5. The one or more NTCRM of claim 1, wherein the one or more SMTCs is 4 SMTCs.

6. The one or more NTCRM of claim 5, wherein the IE is a MeasObjectNR IE.

7. The one or more NTCRM of claim 1, wherein the configuration information further includes an indication of a maximum number of physical cell IDs per SMTC window.

8. The one or more NTCRM of claim 1, wherein the SMTC windows are for intra-frequency measurements.

9. The one or more NTCRM of claim 1, wherein the SMTC windows are for inter-frequency measurements.

10. The one or more NTCRM of claim 9, wherein the IE further includes: a list of inter-frequency cells with specific cell re-selection parameters; and a list of blacklisted inter-frequency cells.

11. One or more non-transitory computer-readable media (NTCRM) having instructions, stored thereon, that when executed by one or more processors cause an integrated access and backhaul (IAB) parent node to:
determine configuration information for a plurality of synchronization signal/physical broadcast channel (PBCH) block (SSB) measurement time configurations (SMTCs) for an IAB mobile termination (MT) of an IAB child node; and
encode, for transmission to the IAB MT via radio resource control (RRC) signaling, an information element (IE) that includes the configuration information for the plurality of SMTCs.

12. The one or more NTCRM of claim 11, further comprising encoding an SSB for transmission in one or more or a plurality of SMTC windows that correspond to the respective SMTCs.

13. The one or more NTCRM of claim 11, wherein the configuration information for the plurality of SMTCs includes:
a periodicity and offset of an SMTC window that corresponds to the respective SMTC;
a duration of the SMTC window;
a set of SSBs to be measured within the SMTC window; and
a list of physical cell IDs to be measured during the SMTC window.

14. The one or more NTCRM of claim 11, wherein the configuration information includes a muting pattern to indicate one or more SMTC occasions of the respective SMTC to be muted.

15. The one or more NTCRM of claim 14, wherein the configuration information includes a bitmap to indicate the muting pattern, wherein individual bits of the bitmap indicate whether respective SMTC occasions within a muting pattern group (MPG) of SMTC occasions are to be muted.

16. The one or more NTCRM of claim 11, wherein the plurality of SMTCs is 4 SMTCs.

17. An apparatus to be implemented in an integrated access and backhaul (IAB) mobile termination (MT), the apparatus comprising:
processor circuitry to:
receive an MeasObjectNR information element (IE) via radio resource control (RRC) signaling, wherein the MeasObjectNR IE includes configuration information for a plurality of synchronization signal/physical broadcast channel (PBCH) block (SSB) measurement time configurations (SMTCs) for the IAB MT; and
a memory to store the configuration information.

18. The apparatus of claim 17, wherein the configuration information for the respective one or more SMTC includes:
a periodicity and offset of the SMTC window;
a duration of the SMTC window;
a set of SSBs to be measured within the SMTC window; and
a list of physical cell IDs to be measured during the SMTC window.

19. The apparatus of claim 17, wherein the configuration information includes a muting pattern to indicate one or more SMTC occasions of the respective SMTC to be muted.

20. The apparatus of claim 19, wherein the configuration information includes a bitmap to indicate the muting pattern, wherein individual bits of the bitmap indicate whether respective SMTC occasions within a muting pattern group (MPG) of SMTC occasions are to be muted.

21. The apparatus of claim 17, wherein the plurality of SMTCs is 4 SMTCs.

22. The apparatus of claim 17, wherein the processor circuitry is further to perform measurements on an SSB in one or more SMTC windows that correspond to the respective SMTCs.
